(19) United States
(12) Patent Application Publication
(10) Pub. No.: US 2025/0054044 A1
(43) Pub. Date: Feb. 13, 2025

(54) Outfit Curation by Generative Artificial Intelligence

(71) Applicant: eBay Inc., San Jose, CA (US)

(72) Inventors: Stephen Scaff, San Jose, CA (US); Caleb Matthew Nance, Hillsborough, NC (US); Megan Woodruff, Seattle, WA (US)

(73) Assignee: eBay Inc., San Jose, CA (US)

(21) Appl. No.: 18/474,058

(22) Filed: Sep. 25, 2023

Related U.S. Application Data
(60) Provisional application No. 63/519,213, filed on Aug. 11, 2023.

(51) Int. Cl. G06Q 30/0601; G06F 3/0482

(52) U.S. Cl. CPC G06Q 30/0631; G06F 3/0482; G06Q 30/0633; G06Q 30/0643

(57) ABSTRACT

Outfit curation by generative artificial intelligence is described. A prompt is generated, based on a seed clothing item, for input to generative artificial intelligence to create an outfit that includes the seed clothing item. The prompt is provided to the generative artificial intelligence to cause the generative artificial intelligence to initiate a search of an online marketplace to locate complementary clothing items for the outfit that are available on the online marketplace. Responsive to the search initiated by the generative artificial intelligence, search results containing listings of the complementary clothing items for the outfit that are available on the online marketplace are received. The listings of the complementary clothing items for the outfit are arranged in a user interface for user selection.

### RELATED APPLICATION

This application claims priority under 35 U.S.C. § 119 (e) to U.S. Provisional Patent Application No. 63/519,213, filed Aug. 11, 2023, and titled “Outfit Curation by Generative Artificial Intelligence,” the entire disclosure of which is hereby incorporated by reference.

### BACKGROUND

Online retailers may curate outfits to create visually appealing and cohesive looks that inspire customers and drive sales. Such curation typically involves manual selection by a stylist of clothing, accessories, and other items from the retailer's inventory in a way that showcases their products in the best possible light while also catering to the preferences and needs of their target audience.

### SUMMARY

Outfit curation by generative artificial intelligence is leveraged with an online marketplace. In one or more implementations, a prompt is generated, based on a seed clothing item, for input to generative artificial intelligence to create an outfit that includes the seed clothing item. The prompt is provided to the generative artificial intelligence to cause the generative artificial intelligence to initiate a search of an online marketplace to locate complementary clothing items for the outfit that are available on the online marketplace. Responsive to the search initiated by the generative artificial intelligence, search results that include listings of the complementary clothing items for the outfit that are available on the online marketplace are received. The listings of the complementary clothing items for the outfit are arranged in a user interface for user selection.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIG. 1 is an illustration of an environment in an example implementation that is operable to employ techniques described herein.

FIG. 2 depicts an example of a user interface for outfit curation by generative artificial intelligence.

FIG. 3 depicts an example of another user interface for outfit curation by generative artificial intelligence.

FIG. 4 depicts an example of another user interface for outfit curation by generative artificial intelligence.

FIG. 5 depicts an example of another user interface for outfit curation by generative artificial intelligence.

FIG. 6 depicts an example of another user interface for outfit curation by generative artificial intelligence.

FIG. 7 depicts an example of another user interface for outfit curation by generative artificial intelligence.

FIG. 8 depicts an example of another user interface for outfit curation by generative artificial intelligence.

FIG. 9 depicts an example of another user interface for outfit curation by generative artificial intelligence.

FIG. 10 depicts a procedure in an example implementation of outfit curation by generative artificial intelligence.

FIG. 11 illustrates an example of a system that includes an example computing device that is representative of one or more computing systems and/or devices that may implement the various techniques described herein.

### DETAILED DESCRIPTION

### Overview

Outfit curation by generative artificial intelligence is described. In accordance with the described techniques, an automated outfit curation system uses generative artificial intelligence to automatically curate outfits based on a seed clothing item. In one or more implementations, the automatically curated outfits include clothing items that are available (e.g., listed) on an online marketplace. In one or more implementations, the online marketplace is accessible by decentralized computing devices that correspond to “clients” of the online marketplace, e.g., users that have accounts with the online marketplace. In at least some scenarios, the online marketplace does not generally control actions of the users to use functionality of the online marketplace to list items thereon. For instance, a number (e.g., most) of the users of the online marketplace may not be employed by or otherwise similarly controlled by a company associated with the online marketplace. In this way, the users of the online marketplace may exert more control over the items listed with the online marketplace (e.g., the items that those users decide to list through the online marketplace) than the company associated online marketplace (or its employees or agents).

Due to this, an inventory of the items listed by the online marketplace may change constantly. Indeed, a next item listed by a user of the online marketplace may be unknown to the online marketplace until a user of the online marketplace provides user input to describe and actually cause generation of a listing for the item. As items are added to the online marketplace (e.g., listed for sale) and removed (e.g., purchased or taken down), the inventory of the online marketplace and thus the real-time listing data is ever changing. For example, many users of the online marketplace may list items that are unique to the online marketplace, such that an item is “one of one” listed by the online marketplace. This contrasts with the listings of retailers, which generally have more centralized control over their inventories and thus knowledge of the items being listed on their sites before the items are listed. Such retailers plan for the specific items being listed. With the conventional approaches taken by many retailers, a buyer purchases a number of the same item and even same size, and a central (or at least controlled) authority causes those planned items to be listed.

The ever-changing nature of an online marketplace where decentralized users are capable of affecting the available inventory at any given time, such as by adding unknown items and/or causing various one-off items to be removed, provides a host of challenges. Where the online marketplace supports a great many users (e.g., tens, hundreds, thousands, millions, etc.), for instance, it is impossible for a human to keep track of the inventory of items listed via real-time listing data. This is particularly true because there are a great many listings for items and also because listings for a number of unknown items can be added at unpredictable times. As a result, conventional approaches for curating outfits (e.g., where a human selects clothing items from a known inventory to form an outfit) lack the speed and the processing capacity to keep up with an inventory of available clothing items listed on the online marketplace that is ever-changing, such as due to decentralized control of the items listed on the online marketplace and in some cases the unpredictable nature of the items being listed by a decentralized user base.

Thus, to solve the problems associated with online marketplaces which have ever changing inventories, the automated outfit curation techniques use generative artificial intelligence for outfit curation. In accordance with the described techniques, the automated outfit curation system receives a request to locate clothing items for an outfit that complement a seed clothing item. For example, a request that identifies a seed clothing item (e.g., a red t-shirt) is received, and the automated outfit curation system curates an outfit that includes complementary clothing items, such as a pair of pants, shoes, a hat, and accessories that complement the seed clothing item. The automated outfit curation system can receive requests in a variety of different ways. In one or more implementations, a user provides an image of a clothing item to the automated outfit curation system, e.g., by uploading or capturing an image of the clothing item. In other implementations, a request is received to curate an outfit based on a clothing item that is listed on the online marketplace. For example, the user may select a clothing item that is available on the online marketplace, and then request curation of an outfit that includes the selected clothing item.

Based on the seed clothing item, the automated outfit curation system automatically generates a prompt for input to the generative artificial intelligence. Generally, the automatically generated prompt asks the generative artificial intelligence to create an outfit that includes the seed clothing item and complementary clothing items for the outfit that are available on the online marketplace. The prompt includes attributes of the seed clothing item as well as predetermined textual input. In some cases, the attributes of the seed clothing item are automatically extracted from an image of the clothing item, e.g., an image provided by a user or an image included in a listing for the clothing item on the online platform.

Providing the prompts to the generative artificial intelligence causes the generative artificial intelligence to initiate a search of the online marketplace to locate complementary clothing items for the outfit that are currently available on the online marketplace. In one or more implementations, for instance, the prompts cause the generative artificial intelligence to provide one or more terms for initiating search queries of the online marketplace. The automated outfit curation system can then use the provided terms as input to the online marketplace's service and/or an application programming interface (API). Thus, in one or more implementations the generative artificial intelligence does not directly initiate the search of the online marketplace, but instead provides the one or more terms for the automated outfit curation system to use to search the online marketplace with the online marketplace's service and/or API. In at least one variation, the generative artificial intelligence, directly initiates the search of the online marketplace. In this way, generative artificial intelligence can create outfits containing complementary clothing items based on a seed clothing item, and then output search queries containing keywords for the complementary clothing items. The search queries are then provided as input to an interface of the online marketplace.

Responsive to the search initiated by the generative artificial intelligence, search results containing listings of the complementary clothing items for the outfit that are currently available on the online marketplace are returned. For example, the search results contain listings of clothing items that complement the seed clothing items and are currently available on the online marketplace. The automated outfit curation system is configured to arrange the listings of the complementary clothing items for the outfit in a user interface for user selection. In one or more implementations, the listings are arranged from “head to toe,” e.g., by placing a hat at a top of the user interface, followed by tops, bottoms, and shoes. The user can then select one or more of the clothing items in order to initiate a transaction for the clothing items to complete the outfit.

In one or more implementations, the systems and techniques described herein are configured to generate groupings of items based on a seed item other than a seed clothing item. For example, a seed item, such as a piece of furniture, may be utilized by the systems and techniques to generate a group of complementary furniture items, e.g., to curate a room or a “space” such as an outdoor space. In this example, the group of complementary furniture items may correspond to other pieces of furniture for a room which match the style of the seed furniture item. As an example, the system may receive an image of a modern couch for a living room, and return a group of furniture items that complement or otherwise match the style of the modern couch, such as a modern coffee table, one or more pieces of modern art, a modern chair, and so forth. Notably the ability to generate a group of complementary items based on a seed item is not limited to clothing and furniture, and may include other types of items without departing from the spirit or scope of the described techniques.

In some aspects, the techniques described herein relate to a computer-implemented method including: generating, based on a seed clothing item, a prompt for input to generative artificial intelligence to create an outfit that includes the seed clothing item, the prompt including clothing attributes of the seed clothing item; providing the prompt to the generative artificial intelligence to cause the generative artificial intelligence to initiate a search of an online marketplace to locate complementary clothing items for the outfit that are available on the online marketplace; responsive to the search initiated by the generative artificial intelligence, receiving search results containing listings of the complementary clothing items for the outfit that are available on the online marketplace; and arranging the listings of the complementary clothing items for the outfit in a user interface for user selection.

In some aspects, the techniques described herein relate to a computer-implemented method, wherein the prompt is automatically generated in response to a request to locate the clothing items for the outfit, the request identifying the seed clothing item.

In some aspects, the techniques described herein relate to a computer-implemented method, wherein the request identifies a style for the outfit.

In some aspects, the techniques described herein relate to a computer-implemented method, wherein the prompt is generated based at least in part on the style for the outfit.

In some aspects, the techniques described herein relate to a computer-implemented method, wherein generating the prompt further includes: extracting the clothing attributes of the seed clothing item; and incorporating the clothing attributes of the seed clothing item into preconfigured text of the prompt.

In some aspects, the techniques described herein relate to a computer-implemented method, wherein the clothing attributes of the seed clothing item are extracted from an image of the seed clothing item.

In some aspects, the techniques described herein relate to a computer-implemented method, further including displaying one or more interactive elements to facilitate selection of the seed clothing item from the image of the seed clothing item.

In some aspects, the techniques described herein relate to a computer-implemented method, further including: outputting an interface to capture the image of the seed clothing item; and receiving, via the interface, input to initiate the capture of the seed clothing item using a camera.

In some aspects, the techniques described herein relate to a computer-implemented method, wherein the clothing attributes of the seed clothing item are extracted from a listing of the seed clothing item on the online marketplace.

In some aspects, the techniques described herein relate to a computer-implemented method, wherein the generative artificial intelligence initiates the search of the online marketplace by automatically generating search queries to locate the clothing items for the outfit, wherein the search queries are automatically provided to a search interface of the online marketplace.

In some aspects, the techniques described herein relate to a computer-implemented method, wherein the online marketplace includes a database of listings of clothing items that continuously changes as different listings of clothing items are added and removed from the database.

In some aspects, the techniques described herein relate to a computer-implemented method, wherein the search results contain listings of the complementary clothing items for the outfit that are currently available in the database of listings.

In some aspects, the techniques described herein relate to a computer-implemented method, further including generating an avatar wearing the seed clothing item and the complementary clothing items.

In some aspects, the techniques described herein relate to a computer-implemented method, wherein providing the prompt to the generative artificial intelligence causes the generative artificial intelligence to initiate a search of an online marketplace to locate complementary clothing items for multiple different outfits that are available on the online marketplace, wherein each of the multiple different outfits are associated with a different style.

In some aspects, the techniques described herein relate to a computer-implemented method, wherein the seed clothing item corresponds to a category of clothing items, wherein the category of the seed clothing item includes one of headwear, a top layer, a bottom layer, shoes, or an accessory, and wherein the complementary clothing items correspond to different categories of clothing items that are different than the category of the seed clothing item.

In some aspects, the techniques described herein relate to a system including: prompt building logic configured to generate, based on a seed clothing item, a prompt for input to generative artificial intelligence to create an outfit that includes the seed clothing item, the prompt including clothing attributes of the seed clothing item; the generative artificial intelligence configured to receive the prompt from the prompt building logic and generate search queries; and an online marketplace configured to receive the search queries from the generative artificial intelligence and initiate a search to locate complementary clothing items for the outfit that are available on the online marketplace;

In some aspects, the techniques described herein relate to a system, wherein the complementary clothing items for the outfit are arranged in a user interface for user selection.

In some aspects, the techniques described herein relate to a system, wherein the prompt building logic is configured to generate the prompt by: extracting the clothing attributes of the seed clothing item; and incorporating the clothing attributes of the seed clothing item into preconfigured text of the prompt.

In some aspects, the techniques described herein relate to a system, wherein the clothing attributes of the seed clothing item are extracted from an image of the seed clothing item.

In some aspects, the techniques described herein relate to one or more computer-readable storage media including computer-executable instructions stored thereon that, responsive to execution by one or more processors, perform operations including: generating, based on a seed clothing item, a prompt for input to generative artificial intelligence to create an outfit that includes the seed clothing item, the prompt including clothing attributes of the seed clothing item; providing the prompt to the generative artificial intelligence to cause the generative artificial intelligence to initiate a search of an online marketplace to locate complementary clothing items for the outfit that are available on the online marketplace; responsive to the search initiated by the generative artificial intelligence, receiving search results containing listings of the complementary clothing items for the outfit that are available on the online marketplace; and arranging the listings of the complementary clothing items for the outfit in a user interface for user selection.

In the following discussion, an exemplary environment is first described that may employ the techniques described herein. Examples of implementation details and procedures are then described which may be performed in the exemplary environment as well as other environments. Performance of the exemplary procedures is not limited to the exemplary environment and the exemplary environment is not limited to performance of the exemplary procedures.

### Example of an Environment

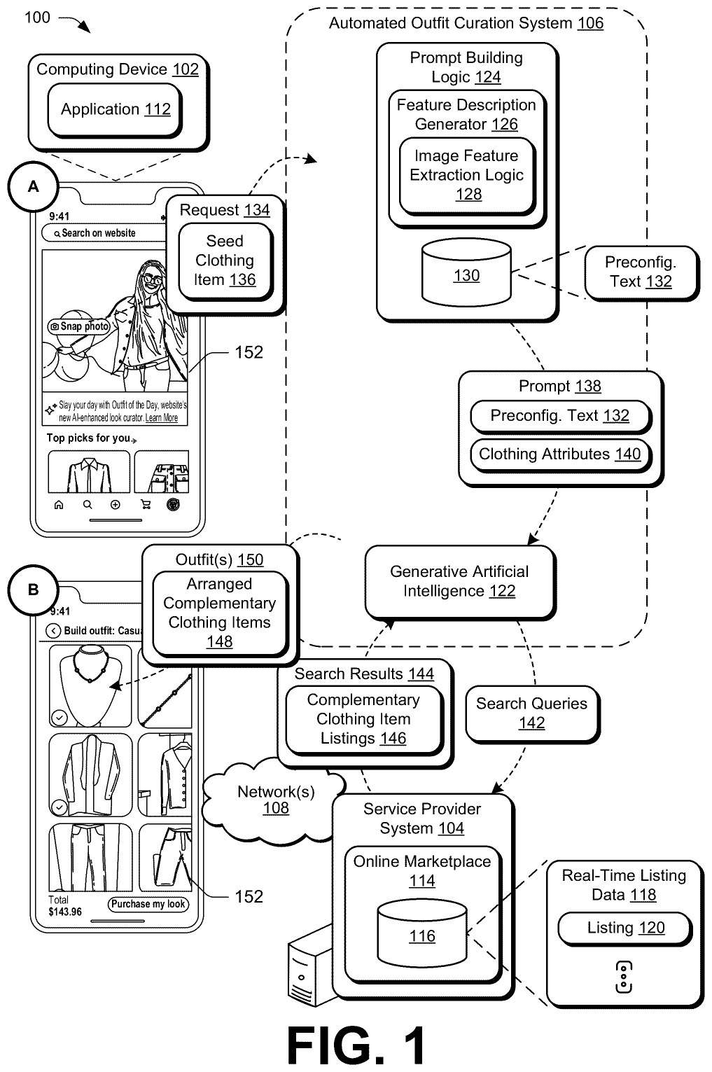

FIG. 1 is an illustration of an environment 100 in an example implementation that is operable to employ techniques described herein. The environment 100 includes a computing device 102, a service provider system 104, and an automated outfit curation system 106. In one or more implementations, the computing device 102, the service provider system 104, and the automated outfit curation system 106 are communicatively coupled, one to another, via network(s) 108. One example of the network(s) 108 is the Internet, although one or more of the computing device 102, the service provider system 104, and the automated outfit curation system 106 may be communicatively coupled using one or more different connections or different networks in various implementations.

Although the automated outfit curation system 106 is depicted in the environment 100 as being separate from the computing device 102 and the service provider system 104, in one or more implementations, an entirety or various portions of the automated outfit curation system 106 are implemented at or by the computing device 102 and/or the service provider system 104. In at least one implementation, for example, at least a portion of the automated outfit curation system 106 is implemented by an application 112 of the computing device 102 and/or using various resources of the computing device 102, such as hardware resources, an operating system, firmware, and so forth. Alternatively or additionally, at least a portion of the automated outfit curation system 106 is implemented by resources (e.g., server-based storage, processing, and so on) of the service provider system 104. Alternatively or additionally, at least a portion of the automated outfit curation system 106 is implemented using a third-party service, such as a web services platform that provides one or more hardware and/or other computing resources to support provision of services by web service providers.

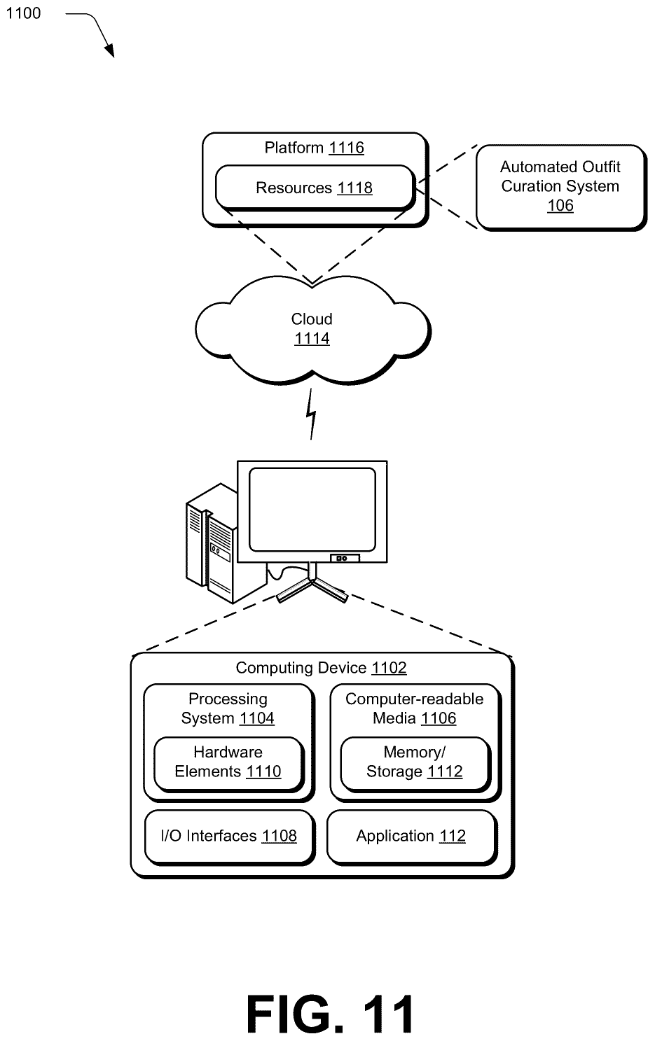

Computing devices that implement the environment 100 are configurable in a variety of ways. A computing device, for instance, is configurable as a desktop computer, a laptop computer, a mobile device (e.g., assuming a handheld configuration such as a tablet or mobile phone), an IoT device, a wearable device (e.g., a smart watch, a ring, or smart glasses), an AR/VR device (e.g., the smart glasses), a server, and so forth. Thus, a computing device ranges from full resource devices with substantial memory and processor resources to low-resource devices with limited memory and/or processing resources. Additionally, although in instances in the following discussion reference is made to a computing device in the singular, a computing device is also representative of a plurality of different devices, such as multiple servers of a server farm utilized to perform operations “over the cloud” as further described in relation to FIG. 11.

In at least one implementation, the application 112 supports communication of data across the network(s) 108 between the computing device 102 and the service provider system 104. By supporting such data communication, the application 112 provides a respective user of the computing device 102 (and users of other computing devices) access to online marketplace 114. For example, the computing device 102 receives data from the service provider system 104. Based on the received data, the application 112 causes various systems of the computing device 102 to output user interfaces of the online marketplace 114, such as by displaying user interfaces via display devices or making accessible voice-based user interfaces.

Through interaction of a user with the computing device 102, the application 112 receives user input via one or more user interfaces of the online marketplace 114. Examples of such input include, but are not limited to, receiving touch input in relation to portions of a displayed user interface, receiving one or more voice commands, receiving typed input (e.g., via a physical or virtual (“soft”) keyboard), receiving mouse or stylus input, and so forth. One example of the application 112 is a browser, which is operable to navigate to a website of the online marketplace 114, display pages of the website, and facilitate user interaction with web pages of the online marketplace 114's website. Another example of the application 112 is a web-based computer application of the online marketplace 114, such as a mobile application or a desktop application. The application 112 may be configured in different ways, which enable users to interact with their computing devices and by extension perform actions on the online marketplace 114, without departing from the spirit or scope of the techniques described herein.

In one or more implementations, users register with the service provider system 104 to obtain respective user accounts with the online marketplace 114. Such registration may include, for instance, providing an email address and establishing a username and password combination. Subsequent to registering with the service provider system 104 computing devices (e.g., the computing device 102) facilitate signing into, or otherwise authenticating to, the user account in various ways, such as by receiving a username and matching password, receiving biometric information (e.g., at least one image captured of a face or information captured of another body part such as a thumb or finger) that suitably matches stored biometric information associated with the user account, and so forth. In at least some scenarios, however, the user account via which a user accesses the online marketplace 114 may be a guest account that does not require a user to sign in or otherwise authenticate to an already established account before interacting with the online marketplace 114.

Broadly speaking, the online marketplace 114 is configured to generate listings for items and to expose those listings (e.g., publish them) to one or more computing devices, including the computing device 102. For example, the online marketplace 114 may generate listings for items for sale and expose those listings to computing devices, such that the users of the computing devices can interact with the listings via user interfaces to initiate transactions (e.g., purchases, add to wish lists, share, and so on) in relation to the respective item or items of the listings. In accordance with the described techniques, the online marketplace 114 is configured to generate listings for one or more types of physical goods or property (e.g., clothing and/or clothing accessories, collectibles, furniture, decorative items, textiles, luxury items, electronics, real property, physical computer-readable storage having one or more video games stored thereon, and so on), services (e.g., babysitting, dog walking, house cleaning, and so on), digital items (e.g., digital images, digital music, digital videos) that can be downloaded via the network(s) 108, and blockchain backed assets (e.g., non-fungible tokens (NFTs)), to name just a few.

In the illustrated environment 100, the online marketplace 114 includes storage device 116, which is depicted maintaining real-time listing data 118. The real-time listing data 118 includes listings of the online marketplace 114, one example of which is listing 120. The real-time listing data 118 is depicted with ellipses to indicate the existence of more listings than the listing 120. The storage device 116 may represent one or more databases and/or other types of storage capable of storing the real-time listing data 118. Examples of the storage device 116 include, but are not limited to, mass storage and virtual storage. In one or more implementations, for example, the storage device 116 may be virtualized across a plurality of data centers and/or cloud-based storage devices. The service provider system 104 may implement the online marketplace 114 by using servers that execute stored instructions to deploy various services of the service provider system 104, such that those services perform numerous computations which are effective to provide the functionality described above and below. It is to be appreciated that the online marketplace 114 may include more, fewer, or different components without departing from the spirit or scope described herein.

In one or more implementations, the online marketplace 114 is accessible by decentralized computing devices that correspond to “clients” of the online marketplace 114, e.g., users that have accounts with the online marketplace 114. In at least some scenarios, but for the provision of accounts and system guardrails implemented by aspects of the online marketplace 114 (e.g., user interfaces of the application 112), the online marketplace 114 does not generally control actions of the users to use functionality of the online marketplace 114 to list items thereon. For instance, a number (e.g., most) of the users of the online marketplace 114 may not be employed by or otherwise similarly controlled by a company associated with the online marketplace 114. In this way, the users of the online marketplace 114 may exert more control over the items listed with the online marketplace 114 (e.g., the items that those users decide to list through the online marketplace 114) than the company associated online marketplace 114 (or its employees or agents).

Due to this, an inventory of the items listed by the online marketplace 114 may change constantly. Indeed, a next item listed by a user of the online marketplace 114 may be unknown to the online marketplace 114 until a user of the online marketplace 114 provides user input to describe and actually cause generation of a listing for the item. As items are added to the online marketplace 114 (e.g., listed for sale) and removed (e.g., purchased or taken down), the inventory of the online marketplace 114 and thus the real-time listing data 118 is ever changing. For example, many users of the online marketplace 114 may list items that are unique to the online marketplace 114, such that an item is “one of one” listed by the online marketplace 114. This contrasts with the listings of retailers, which generally have more centralized control over their inventories and thus knowledge of the items being listed on their sites before the items are listed. Such retailers plan for the specific items being listed. With the conventional approaches taken by many retailers, a buyer purchases a number of the same item and even same size and a central (or at least controlled) authority causes those planned items to be listed.

The ever-changing nature of an online marketplace 114 where decentralized users are capable of affecting the available inventory at any given time, such as by adding unknown items and/or causing various one-off items to be removed, provides a host of challenges. Where the online marketplace 114 supports a great many users (e.g., tens, hundreds, thousands, millions, etc.), for instance, it is impossible for a human to keep track of the inventory of items listed via the real-time listing data 118. This is particularly true because there are a great many listings for items and also because listings for a number of unknown items can be added at unpredictable times. As a result, conventional approaches for curating outfits (e.g., where a human selects clothing items from a known inventory to form an outfit) lack the speed and the processing capacity to keep up with an inventory of available clothing items listed on the online marketplace 114 that is ever-changing, such as due to decentralized control of the items listed on the online marketplace 114 and in some cases the unpredictable nature of the items being listed by a decentralized user base.

In accordance with the described techniques, the automated outfit curation system 106 uses generative artificial intelligence 122 for outfit curation. In this example, the automated outfit curation system 106 includes or otherwise has access to the generative artificial intelligence 122 and prompt building logic 124. In one or more implementations, the generative artificial intelligence 122 leverages a class of artificial intelligence technologies and techniques that involve creation of novel and original content, data, and/or artifacts. Unlike traditional artificial intelligence systems that rely on rule-based or deterministic approaches, generative artificial intelligence employs algorithms and models capable of autonomously producing output that closely resembles human-generated content. These algorithms are designed to learn patterns and structures from existing data and then use this learned information to generate new content that is coherent, relevant, and contextually appropriate. Although the techniques are described leveraging generative artificial intelligence, in variations, different types of artificial intelligence may be leveraged without departing from the spirit or scope of the described techniques.

In the illustrated environment 100, the prompt building logic 124 includes feature description generator 126 with image feature extraction logic 128 and also includes storage device 130, which is depicted storing preconfigured text 132. The storage device 130 may represent one or more databases and/or other types of storage capable of storing the preconfigured text 132 and/or other data used by the generative artificial intelligence 122 to curate outfits in real-time from the clothing items on the online marketplace 114 available at a particular time. Examples of the storage device 130 include, but are not limited to, mass storage and virtual storage. In one or more implementations, for example, the storage device 130 may be virtualized across a plurality of data centers and/or cloud-based storage devices.

In one or more implementations, the automated outfit curation system 106 receives a request 134 to locate clothing items for an outfit. In at least one variation, the request 134 identifies or otherwise indicates a seed clothing item 136. By way of example and not limitation, the request 134 includes an image of the seed clothing item 136, text describing the seed clothing item 136, and/or a selection of the seed clothing item 136, e.g., a selection of a listing in the real-time listing data 118 which lists the seed clothing item 136. The automated outfit curation system 106 uses the seed clothing item 136 for curating one or more outfits. While the use of only one seed clothing item is discussed, in at least one variation, multiple seed clothing items may be identified (e.g., images, text, and/or selections provided which indicate the multiple seed clothing items), such that the automated outfit curation system 106 curates one or more outfits based on multiple seed clothing items.

Based on the seed clothing item 136, the prompt building logic 124 builds or otherwise generates a prompt 138 for input to the generative artificial intelligence 122 to create an outfit that includes the seed clothing item 136 and/or is based on the seed clothing item 136. In accordance with the described techniques, the prompt 138 includes clothing attributes 140 of the seed clothing item 136.

In one or more implementations, the prompt building logic 124 builds the prompt 138 by combining a partial prompt with the clothing attributes 140. For instance, the prompt building logic 124 combines the preconfigured text 132 with the clothing attributes 140, e.g., one or more text words and/or phrases describing the extracted clothing attributes. As a non-limiting example, the preconfigured text 132 may correspond to a text string, such as “Please determine three different styles and create an outfit for each of those styles using available clothing items from the online marketplace that is based on [clothing attributes]”. Additionally, the prompt building logic 124 may extract the clothing attributes 140 of the seed clothing item 136, such as “white” “graphic” “t-shirt.” The prompt building logic 124 can then combine the preconfigured text 132 and the clothing attributes 140 to generate a prompt 138, such as “Please determine three different styles and create an outfit for each of those styles using available clothing items from the online marketplace that is based on a white graphic t-shirt.” In other words, the prompt building logic 124 may concatenate the text of the preconfigured text 132 with text corresponding to the clothing attributes 140. The automated outfit curation system 106 provides the prompt 138 as input to the generative artificial intelligence 122. It is to be appreciated that the preconfigured text 132 may vary from the example provided just above without departing from the spirit or scope of the techniques described herein.

Additionally or alternatively, the prompt building logic 124 may form a prompt 138 using a partial prompt that is preconfigured, but that is a different type of information from human-readable text, such as a partial feature vector, which is not human understandable text. In such implementations, the clothing attributes 140 also may be extracted and indicated using information that is different from human-readable text. In one or more variations, for instance, the clothing attributes 140 may be expressed in a feature vector format such that they can be combined with a partial feature vector to form a prompt which is a feature vector. The prompt 138 may be formatted in a variety of ways for input to the generative artificial intelligence 122 without departing from the spirit or scope of the techniques described herein.

In one or more implementations, the feature description generator 126 generates the clothing attributes 140 based on the seed clothing item 136. Here, the feature description generator 126 includes the image feature extraction logic 128, which is configured to receive an image depicting a clothing item as input and process the image to output the clothing attributes 140 of the clothing item. In one or more implementations, for instance, an image of the seed clothing item 136 is provided as input to the image feature extraction logic 128. The image feature extraction logic 128 processes the image of the seed clothing item 136 to extract one or more image features from the image. The image feature extraction logic 128 then generates and outputs the clothing attributes 140 (e.g., text tags, text strings, or other suitable format of information) based on the extracted image features. It is to be appreciated that the image feature extraction logic 128 may be configured as, include, and/or have access to any of a variety of known technologies (e.g., object recognition, bounding boxes, saliency maps, etc.) to process an image of the seed clothing item 136 to extract the clothing attributes 140 of the seed clothing item 136 from the image.

As noted above, the seed clothing item 136 may be identified in other ways, such as via user text input and/or a selection of an item listed on the online marketplace 114. To this end, the feature description generator 126 may be configured in variations to determine the clothing attributes 140 of the seed clothing item 136 in different manners which are based on how the seed clothing item 136 is identified. Where the seed clothing item 136 is identified with user input text, for example, the feature description generator 126 may extract the clothing attributes 140 using one or more text-focused techniques, such as natural language processing (NLP) techniques. Where the seed clothing item 136 is identified based on a selection of a listed clothing item, the feature description generator 126 may obtain one or more of an image of the respective listing, a title of the listing, a description of the listing, a category associated with the listing, or underlying data (e.g., metadata of the listing), to name just a few. The feature description generator 126 may then use the obtained data as the clothing attributes 140 for incorporation into the prompt 138 and/or the feature description generator 126 may further process the obtained information to extract the clothing attributes 140 from the listing, e.g., a combination of image feature extraction techniques and/or NLP techniques. It is to be appreciated that the clothing attributes 140 may be extracted from different formats of information corresponding to the seed clothing item 136 in various ways in accordance with the described techniques.

After the prompt 138 is generated, the automated outfit curation system 106 provides the prompt 138 as input to the generative artificial intelligence 122. Providing the prompt 138 as input to the generative artificial intelligence 122 causes the generative artificial intelligence 122 to initiate a search of the online marketplace 114, such as a search to locate complementary clothing items for the outfit that are complementary to the seed clothing item 136 and that are available on the online marketplace 114. In one or more implementations, the prompt 138 indicates that the seed clothing item 136 is to be included as part of the one or more outfits being curated. Alternatively or in addition, the generative artificial intelligence 122 is trained or otherwise programmed so that it incorporates the seed clothing item 136 into the outfits that it outputs.

In one or more implementations, the generative artificial intelligence 122 automatically generates search queries 142 based on receipt of the prompt 138 and provides the search queries 142 as input to a search interface of the online marketplace 114. By way of example, the generative artificial intelligence 122 generates multiple different search queries based on the prompt 138, such as multiple search queries that each correspond to a different determined style of an outfit. The generative artificial intelligence 122 may provide the search queries 142 to different types of search interfaces of the online marketplace 114. In at least one implementation, for example, the generative artificial intelligence 122 may generate text search queries (e.g., using one or more NLP techniques) and provide the text search queries as input to a search interface that is or includes an interactive element such as a search bar. Alternatively or in addition, the search interface corresponds to an application programming interface (API), such that at least one of the generative artificial intelligence 122 or the automated outfit curation system 106 configures the search queries 142 in accordance with the API and provides the search queries 142 as input to the online marketplace 114's API. The generative artificial intelligence 122 may initiate a search of the online marketplace 114 to locate complementary clothing items for an outfit in a variety of ways without departing from the spirit or scope of the described techniques.

Responsive to the search initiated by the generative artificial intelligence 122, the automated outfit curation system 106 receives search results 144 that include or otherwise indicate complementary clothing item listings 146 on the online marketplace 114. In other words, the search results 144 include listings, from the real-time listing data 118, of the complementary clothing items for an outfit that are available on the online marketplace 114 at the particular time the outfit is requested, e.g., in substantially real-time as the request 134 for a curated outfit is submitted by the computing device 102.

In one or more implementations, the complementary clothing item listings 146 are arranged to create outfit(s) 150 for a user interface, where the complementary clothing item listings 146 that are combined to form the outfit(s) 150 are selectable (e.g., to add to a cart and/or purchase). In at least one implementation, the generative artificial intelligence 122 arranges the complementary clothing item listings 146 into one or more outfits, e.g., a number of outfits specified in the prompt 138. In other words, the generative artificial intelligence 122 arranges various listings of the complementary clothing item listings 146 to produce arranged complementary clothing items 148, where each arrangement forms one of the outfit(s) 150.

In one example, the preconfigured text 132 specifies to provide clothing items for three outfits, although different numbers of outfits may be specified without departing from the spirit or scope of the described techniques. For instance, the number of outfits specified may be user selectable and/or adjustable, e.g., from a default number. In at least one implementation, each outfit created by the generative artificial intelligence 122 is a “full” outfit. One non-limiting example of a full outfit includes at least the clothing items of a top, bottoms, and footwear and optionally includes additional items such as headwear, accessories (e.g., jewelry, watches, bags, eyewear, etc.), additional top layers (e.g., vests, jackets, blazers, sweaters, etc.), additional bottom layers (e.g., leggings, skirts, skorts, shorts, etc.), and so forth. Indeed, clothing items which may be combined to create an outfit may correspond to any of a variety of types and/or categories of clothing items without departing from the spirit or scope of the techniques described herein.

The illustrated environment 100 depicts the computing device 102 at two different times, i.e., a first time ‘A’ and a second time ‘B’ that is after the first time. At the first time, time ‘A,’ the computing device 102 is depicted displaying a user interface 152 (e.g., of the application 112) that includes an interactive element that is selectable via user input to submit a request to locate clothing items for an outfit. At the second time, time ‘B,’ the user interface 152 is depicted including outfit(s) 150 formed to include arranged complementary clothing items 148 and also including interactive elements that are selectable to initiate an action in relation to respective clothing items. In at least one implementation, the user interface 152 includes an interactive element for each clothing item of the arranged complementary clothing items 148 included in the user interface. Such interactive elements may be selectable to perform an action in relation only to the respective clothing item, such as to add the respective clothing item to an electronic shopping cart or electronic shopping bag of the online marketplace 114, purchase the respective clothing item, add the respective clothing item to a watch list, and so forth. Alternatively or in addition, the user interface may include an interactive element that is selectable to initiate an action in relation to more than one of the clothing items, such as an interactive element that is selectable to initiate a purchase of all the clothing items which form one of the outfit(s) 150 or to perform a different action in relation to all the clothing items which form one of the outfit(s) 150, e.g., add the clothing items of the outfit to an electronic shopping cart or electronic shopping bag.

The user interface 152 may be configured in a variety of ways to display the outfit(s) 150 and/or various items of the arranged complementary clothing items 148 to a user. In one or more implementations, the user interface 152 may include an avatar, and a virtual version of at least one of the outfit(s) 150 may be generated for display on the avatar. Additionally or alternatively, a user may be able to provide input to deselect and/or select various clothing items from the arranged complementary clothing items 148 included in the outfit(s) 150 to change which of the arranged complementary clothing items 148 are simulated on the avatar. In one or more implementations, the user interface 152 is generated to display the arranged complementary clothing items 148 of the outfit(s) 150 from top to bottom (e.g., head to toe), such that clothing items generally worn closer to a top of a person (e.g., hats, necklaces, and tops) are displayed closer to a top of the user interface 152 and such that clothing items generally worn closer to a bottom of a person (e.g., pants, skirts, socks, and footwear) are displayed closer to a bottom of the user interface 152. Alternatively or in addition, the user interface 152 may be configured in a grid, such that a column of the arranged complementary clothing items 148 corresponds to a combination of clothing items that form an outfit and such that a row of the arranged complementary clothing items 148 correspond to different options for a portion of the outfit. For example, a row may include images of different tops such that a user can select from different recommended tops in the user interface 152 to form an outfit. In one or more implementations, the user interface 152 may allow a user to horizontally scroll through an individual row to view the different options of the category while the other clothing items of the outfit (e.g., the other portions of the outfit in the vertical arrangement) remain stationary.

In one or more implementations, the request 134 identifies a style for the outfit, and the prompt 138 is generated based at least in part on the style. Alternatively or additionally, one or more styles associated with a user submitting the request are accessed (e.g., from user data of the online marketplace 114), and the prompt 138 is generated based at least in part on those one or more styles. For instance, a style or styles of a user may be learned by the online marketplace 114 over time, such as based on one or more of a purchase history, browsing history, likes, comments, demographics, social media behavior, images uploaded and/or specified by the user, determined similar users, and so on. Thus, the automated outfit curation system 106 may, at least in part, leverage historical style information to curate the outfit(s) 150 in one or more implementations.

In one or more implementations, the listings of clothing items for the outfit are automatically filtered based on one or more characteristics or preferences of a user. For example, the listings of clothing items for the outfit may be filtered to only include clothing items which are a correct, determined, or specified size for the user.

In one or more implementations, the automated outfit curation system 106 generates multiple different outfits which each include the seed clothing item. The multiple different outfits, for example, may each be associated with a different style. The different styles of the outfits, in some cases, may be based on user input or learned user preferences.

In one or more implementations, the user interface displays multiple different listings for each of the clothing item. For example, the user interface may display multiple different listings of similar hats. These multiple different listings, in some cases, may be scrolled by the user so that the user can select a preferred clothing item.

In one or more implementations, the automated outfit curation system 106 automatically generates an avatar of the user wearing the outfit. For example, a three-dimensional avatar of the user wearing the seed clothing item and the complementary clothing items may be generated and displayed via a user interface.

In one or more implementations, the prompt 138 for the generative artificial intelligence 122 excludes a clothing type of the seed clothing item 136. For example, if the seed clothing item is a red shirt, then the prompt 138 asks the generative artificial intelligence 122 to locate clothing items other than shirts which complement the seed clothing item 136.

In one or more implementations, an image of the seed clothing item 136 included in the user interface along with images of the complementary clothing items.

In one or more implementations, the generative artificial intelligence 122 initiates a search of multiple different online platforms or marketplaces. For example, the search queries 142 generated by the generative artificial intelligence 122 may be provided to the online marketplace 114 as well as one or more different online marketplaces, one or more online stores, one or more online search engines, and so forth.

Having considered an example of an environment, consider now a discussion of some example details of the techniques for outfit curation by generative artificial intelligence in accordance with one or more implementations.

### Outfit Curation by Generative Artificial Intelligence

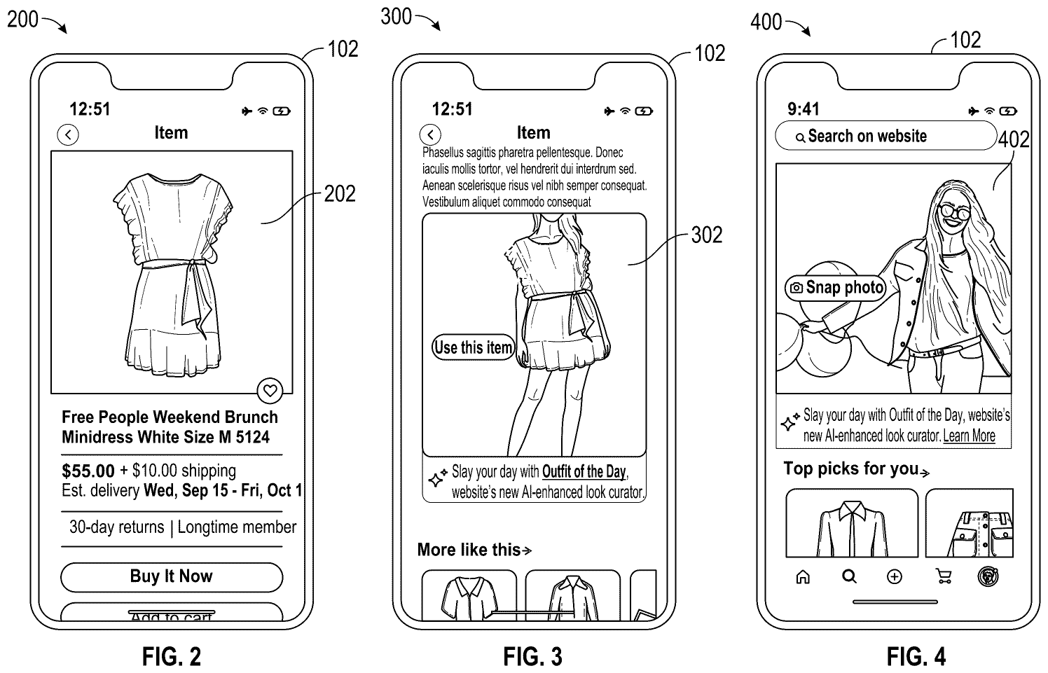

FIG. 2 depicts an example 200 of a user interface for outfit curation by generative artificial intelligence.

The illustrated example 200 includes the computing device 102 displaying a view item user interface 202. The view item user interface 202 corresponds to a page generated to display a listing (e.g., the listing 120) generated for a clothing item listed by the online marketplace 114 and published, e.g., to one or more computing devices. In one or more implementations, one or more interactive elements that are selectable to initiate outfit curation using the generative artificial intelligence 122 are accessible via the view item user interface 202, e.g., such interactive elements are included on the view item user interface 202 and/or a user interface with such an element is navigable from the view item user interface 202. In one or more implementations, user interfaces of the online marketplace 114 and/or that enable outfit curation by generative artificial intelligence are different or otherwise vary from the user interfaces discussed herein. Alternatively or additionally, user interfaces used in connection with outfit curation by generative artificial intelligence include any combination of the user interface elements discussed herein and/or depicted in FIGS. 2-9 without departing from the spirit or scope of the techniques described herein.

FIG. 3 depicts an example 300 of another user interface for outfit curation by generative artificial intelligence.

The illustrated example 300 includes the computing device 102 displaying a listed item selection user interface 302. The listed item selection user interface 302 includes an interactive element that is selectable to identify the respective listed clothing item as the seed clothing item 136.

FIG. 4 depicts an example 400 of another user interface for outfit curation by generative artificial intelligence.

The illustrated example 400 includes the computing device 102 displaying a capture item image user interface 402. The capture item image user interface 402 includes an interactive element that is selectable to identify a clothing item from an image captured by a user and/or from a selected image in an image library or album associated with the user (e.g., accessible via the computing device 102) as the seed clothing item 136.

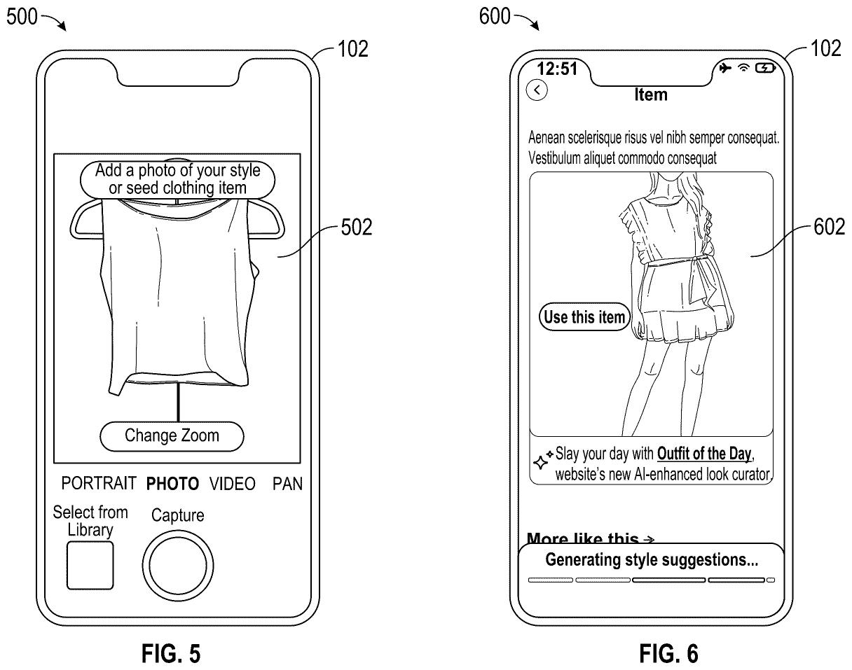

FIG. 5 depicts an example 500 of another user interface for outfit curation by generative artificial intelligence.

The illustrated example 500 includes the computing device 102 displaying an image capture user interface 502. The image capture user interface 502 includes one or more interactive elements that are selectable to capture an image of a scene, such as a scene that includes a clothing item. In one or more implementations, image capture user interface 502 displays a preview of a portion of a scene by continuously and directly projecting an image formed by lenses of one or more cameras of the computing device 102 onto an image sensor, such that when capture is initiated the previewed scene is formatted into a captured image. In this way, an image captured based on input to interactive elements of the image capture user interface 502 may be used as the seed clothing item 136.

FIG. 6 depicts an example 600 of another user interface for outfit curation by generative artificial intelligence.

The illustrated example 600 includes the computing device 102 displaying a progress user interface 602. In one or more implementations, the automated outfit curation system 106 causes the progress user interface 602 to be displayed for a time interval that spans between a first time when the request 134 is submitted and a second time when the outfit(s) 150 with the arranged complementary clothing items 148 are provided in a user interface back to the computing device 102. For instance, the progress user interface 602 may be displayed while the prompt building logic 124 forms the prompt 138, while the prompt 138 is input to the generative artificial intelligence 122, while the generative artificial intelligence 122 generates the search queries 142 and provides them to the online marketplace 114, while the online marketplace 114 searches the real-time listing data 118 for the complementary clothing item listings 146, while the search results 144 are sent to the generative artificial intelligence 122, and/or while the generative artificial intelligence 122 arranges the complementary clothing item listings 146 into the outfit(s) 150.

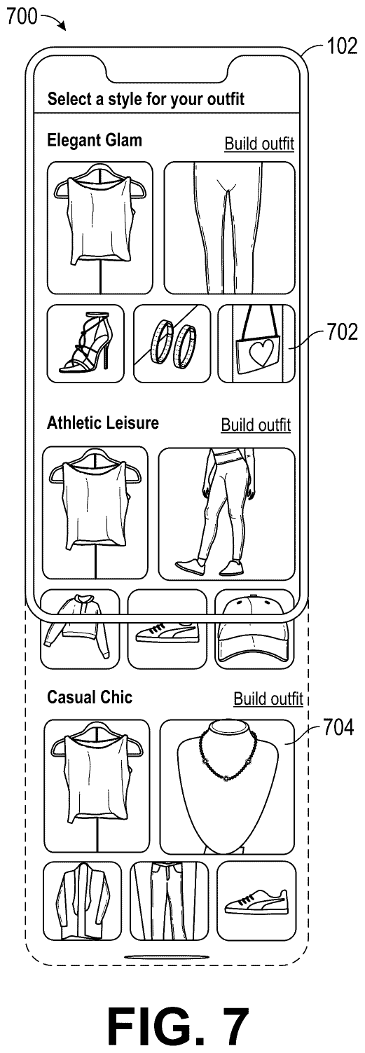

FIG. 7 depicts an example 700 of another user interface for outfit curation by generative artificial intelligence.

The illustrated example 700 includes the computing device 102 displaying an outfit selection user interface 702. In this example 700, the outfit selection user interface 702 includes three outfit(s) 150 which each include arranged complementary clothing items 148, as determined by the generative artificial intelligence 122. The outfit selection user interface 702 also includes interactive elements (e.g., “Build outfit”) that are selectable to navigate to an outfit specific page to build an outfit, select individual items of the outfit (e.g., for purchase), and/or to select multiple items of the outfit (e.g., for purchase). The illustrated example 700 also includes extended user interface portion 704, which may not be initially viewable when the outfit selection user interface 702 is displayed on the computing device 102, but which may be viewed responsive to user input to scroll down to the extended user interface portion. In this example 700, the outfit(s) 150 included in the display are associated with the respective style names “Elegant Glam,” “Athletic Leisure,” and “Casual Chic.” In one or more implementations, these style names are generated and provided by the generative artificial intelligence 122.

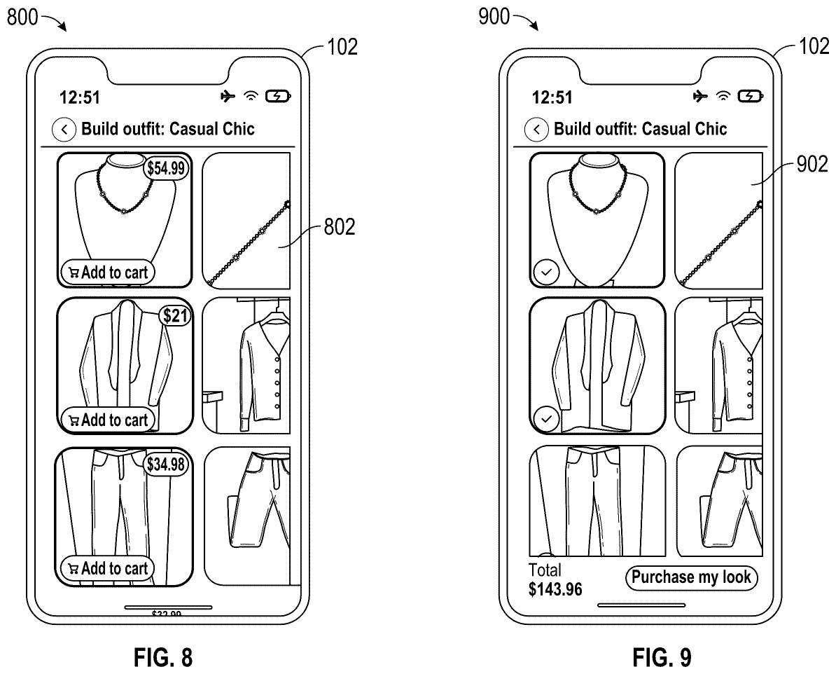

FIG. 8 depicts an example 800 of another user interface for outfit curation by generative artificial intelligence.

The illustrated example 800 includes the computing device 102 displaying an item selection user interface 802 of one of the outfit(s) 150. The item selection user interface 802 includes interactive elements displayed over images of different arranged complementary clothing items 148 of the outfit(s) 150 that are selectable to perform an action in relation to the listing of the depicted item, e.g., add the item of the respective listing to an electronic cart of the online marketplace 114. In this example, each of the images includes an interactive element, which is selectable to add only the respective item to the cart, but not add other items to the cart.

FIG. 9 depicts an example 900 of another user interface for outfit curation by generative artificial intelligence.

The illustrated example 900 includes the computing device 102 displaying an outfit selection user interface 902. The outfit selection user interface 902 includes interactive elements to select multiple clothing items of the arranged complementary clothing items 148, and then one interactive element to perform a common action in relation to all the selected clothing items, e.g., to purchase all of the selected clothing items. In this way, a user can interact with a single interactive element to purchase multiple clothing items (from different listings) that have been arranged by the generative artificial intelligence 122 into one of the outfit(s) 150.

Having discussed exemplary details of outfit curation by generative artificial intelligence, consider now some examples of procedures to illustrate additional aspects of the techniques.

### Example Procedures

This section describes examples of procedures for outfit curation by generative artificial intelligence. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks.

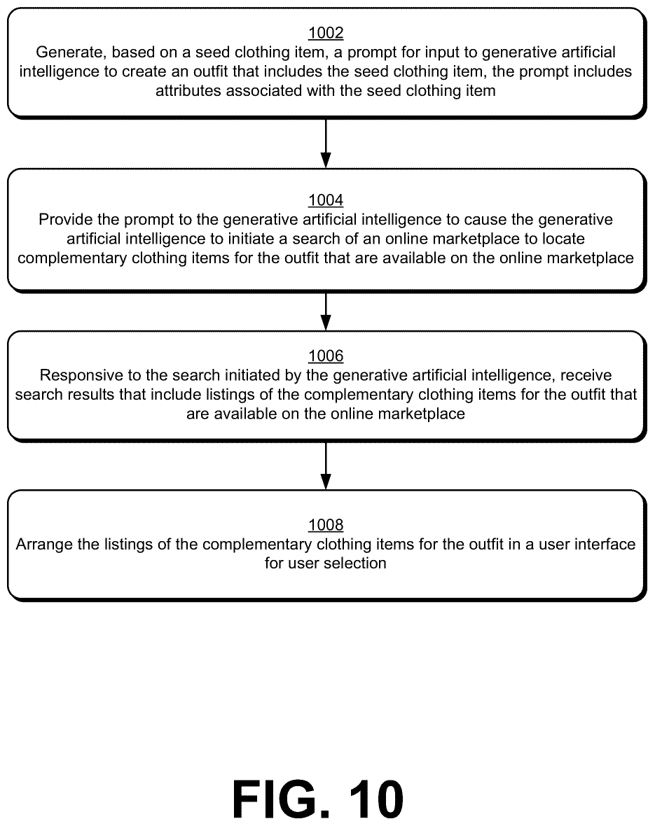

FIG. 10 depicts a procedure 1000 in an example implementation of outfit curation by generative artificial intelligence.

A prompt for input to generative artificial intelligence to create an outfit that includes a seed clothing item is generated based on the seed clothing item (block 1002). In accordance with the described techniques, the prompt includes attributes of the seed clothing item. By way of example, the automated outfit curation system 106 generates a prompt 138 for input to the generative artificial intelligence 122 to create an outfit 150 that includes the seed clothing item 136 based on a request that identifies the seed clothing item 136. The prompt 138 includes clothing attributes 140 of the seed clothing item 136.

The prompt is provided to the generative artificial intelligence to cause the generative artificial intelligence to initiate a search of an online marketplace to locate complementary clothing items for the outfit that are available on the online marketplace (block 1004). By way of example, the prompt building logic 124 of the automated outfit curation system 106 provides the prompt 138 to the generative artificial intelligence 122 to initiate a search of the online marketplace 114 to locate complementary clothing items for the outfit 150 that are available on the online marketplace 114.

Responsive to the search initiated by the generative artificial intelligence, search results containing listings of the complementary clothing items for the outfit that are available on the online marketplace are received (block 1006). By way of example, responsive to the search initiated by generative artificial intelligence 122, search results 144 containing complementary clothing item listings 146 for the outfit 150 that are available on the online marketplace 114 are received.

The listings of the complementary clothing items for the outfit are arranged in a user interface for user selection (block 1008). By way of example, the arranged complementary clothing items 148 are output via one or more of the outfit selection user interface 702, the item selection user interface 802, or the outfit selection user interface 902 for user selection.

Having described examples of procedures in accordance with one or more implementations, consider now an example of a system and device that can be utilized to implement the various techniques described herein.

### Example System and Device

FIG. 11 illustrates an example of a system generally at 1100 that includes an example of a computing device 1102 that is representative of one or more computing systems and/or devices that may implement the various techniques described herein. This is illustrated through inclusion of the application 112 and the automated outfit curation system 106. The computing device 1102 may be, for example, a server of a service provider, a device associated with a client (e.g., a client device), an on-chip system, and/or any other suitable computing device or computing system.

The example computing device 1102 as illustrated includes a processing system 1104, one or more computer-readable media 1106, and one or more I/O interfaces 1108 that are communicatively coupled, one to another. Although not shown, the computing device 1102 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1104 is representative of functionality to perform one or more operations using hardware. Accordingly, the processing system 1104 is illustrated as including hardware elements 1110 that may be configured as processors, functional blocks, and so forth. This may include implementation in hardware as an application specific integrated circuit or other logic device formed using one or more semiconductors. The hardware elements 1110 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1106 is illustrated as including memory/storage 1112. The memory/storage 1112 represents memory/storage capacity associated with one or more computer-readable media. The memory/storage 1112 may include volatile media (such as random access memory (RAM)) and/or nonvolatile media (such as read only memory (ROM), Flash memory, optical disks, magnetic disks, and so forth). The memory/storage 1112 may include fixed media (e.g., RAM, ROM, a fixed hard drive, and so on) as well as removable media (e.g., Flash memory, a removable hard drive, an optical disc, and so forth). The computer-readable media 1106 may be configured in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1102 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1102. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1102, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1110 and computer-readable media 1106 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1110. The computing device 1102 may be configured to implement particular instructions and/or functions corresponding to the software and/or hardware modules. Accordingly, implementation of a module that is executable by the computing device 1102 as software may be achieved at least partially in hardware, e.g., through use of computer-readable storage media and/or hardware elements 1110 of the processing system 1104. The instructions and/or functions may be executable/operable by one or more articles of manufacture (for example, one or more computing devices 1102 and/or processing systems 1104) to implement techniques, modules, and examples described herein.

The techniques described herein may be supported by various configurations of the computing device 1102 and are not limited to the specific examples of the techniques described herein. This functionality may also be implemented all or in part through use of a distributed system, such as over a “cloud” 1114 via a platform 1116 as described below.

The cloud 1114 includes and/or is representative of a platform 1116 for resources 1118. The platform 1116 abstracts underlying functionality of hardware (e.g., servers) and software resources of the cloud 1114. The resources 1118 may include applications and/or data that can be utilized while computer processing is executed on servers that are remote from the computing device 1102. Resources 1118 can also include services provided over the Internet and/or through a subscriber network, such as a cellular or Wi-Fi network.

The platform 1116 may abstract resources and functions to connect the computing device 1102 with other computing devices. The platform 1116 may also serve to abstract scaling of resources to provide a corresponding level of scale to encountered demand for the resources 1118 that are implemented via the platform 1116. Accordingly, in an interconnected device embodiment, implementation of functionality described herein may be distributed throughout the system 1100. For example, the functionality may be implemented in part on the computing device 1102 as well as via the platform 1116 that abstracts the functionality of the cloud 1114.

### CONCLUSION

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A computer-implemented method comprising:
generating, based on a seed clothing item, a prompt for input to generative artificial intelligence to create an outfit that includes the seed clothing item, the prompt including clothing attributes of the seed clothing item;
providing the prompt to the generative artificial intelligence to cause the generative artificial intelligence to initiate a search of an online marketplace to locate complementary clothing items for the outfit that are available on the online marketplace;
responsive to the search initiated by the generative artificial intelligence, receiving search results containing listings of the complementary clothing items for the outfit that are available on the online marketplace; and
arranging the listings of the complementary clothing items for the outfit in a user interface for user selection.

2. The computer-implemented method of claim 1, wherein the prompt is automatically generated in response to a request to locate the clothing items for the outfit, the request identifying the seed clothing item.

3. The computer-implemented method of claim 2, wherein the request identifies a style for the outfit.

4. The computer-implemented method of claim 3, wherein the prompt is generated based at least in part on the style for the outfit.

5. The computer-implemented method of claim 1, wherein generating the prompt further comprises:
extracting the clothing attributes of the seed clothing item; and
incorporating the clothing attributes of the seed clothing item into preconfigured text of the prompt.

6. The computer-implemented method of claim 5, wherein the clothing attributes of the seed clothing item are extracted from an image of the seed clothing item.

7. The computer-implemented method of claim 6, further comprising displaying one or more interactive elements to facilitate selection of the seed clothing item from the image of the seed clothing item.

8. The computer-implemented method of claim 6, further comprising:
outputting an interface to capture the image of the seed clothing item; and
receiving, via the interface, input to initiate the capture of the seed clothing item using a camera.

9. The computer-implemented method of claim 5, wherein the clothing attributes of the seed clothing item are extracted from a listing of the seed clothing item on the online marketplace.

10. The computer-implemented method of claim 1, wherein the generative artificial intelligence initiates the search of the online marketplace by automatically generating search queries to locate the clothing items for the outfit, wherein the search queries are automatically provided to a search interface of the online marketplace.

11. The computer-implemented method of claim 1, wherein the online marketplace includes a database of listings of clothing items that continuously changes as different listings of clothing items are added and removed from the database.

12. The computer-implemented method of claim 11, wherein the search results contain listings of the complementary clothing items for the outfit that are currently available in the database of listings.

13. The computer-implemented method of claim 1, further comprising generating an avatar wearing the seed clothing item and the complementary clothing items.

14. The computer-implemented method of claim 1, wherein providing the prompt to the generative artificial intelligence causes the generative artificial intelligence to initiate a search of an online marketplace to locate complementary clothing items for multiple different outfits that are available on the online marketplace, wherein each of the multiple different outfits are associated with a different style.

15. The computer-implemented method of claim 1, wherein the seed clothing item corresponds to a category of clothing items, wherein the category of the seed clothing item comprises one of headwear, a top layer, a bottom layer, shoes, or an accessory, and wherein the complementary clothing items correspond to different categories of clothing items that are different than the category of the seed clothing item.

16. A system comprising:
prompt building logic configured to generate, based on a seed clothing item, a prompt for input to generative artificial intelligence to create an outfit that includes the seed clothing item, the prompt including clothing attributes of the seed clothing item;
the generative artificial intelligence configured to receive the prompt from the prompt building logic and generate search queries; and
an online marketplace configured to receive the search queries from the generative artificial intelligence and initiate a search to locate complementary clothing items for the outfit that are available on the online marketplace.

17. The system of claim 16, wherein the complementary clothing items for the outfit are arranged in a user interface for user selection.

18. The system of claim 16, wherein the prompt building logic is configured to generate the prompt by:
extracting the clothing attributes of the seed clothing item; and
incorporating the clothing attributes of the seed clothing item into preconfigured text of the prompt.

19. The system of claim 18, wherein the clothing attributes of the seed clothing item are extracted from an image of the seed clothing item.

20. One or more computer-readable storage media comprising computer-executable instructions stored thereon that, responsive to execution by one or more processors, perform operations comprising:
generating, based on a seed clothing item, a prompt for input to generative artificial intelligence to create an outfit that includes the seed clothing item, the prompt including clothing attributes of the seed clothing item;
providing the prompt to the generative artificial intelligence to cause the generative artificial intelligence to initiate a search of an online marketplace to locate complementary clothing items for the outfit that are available on the online marketplace;
responsive to the search initiated by the generative artificial intelligence, receiving search results containing listings of the complementary clothing items for the outfit that are available on the online marketplace; and
arranging the listings of the complementary clothing items for the outfit in a user interface for user selection.
